(19) United States
(12) Patent Application Publication
(10) Pub. No.: US 2011/0191789 A1
(43) Pub. Date: Aug. 4, 2011

(54) APPLICATION EXECUTING APPARATUS AND METHOD

(75) Inventor: Sung-Jae PARK, Suwon-si (KR)

(73) Assignee: Samsung Electronics Co., Ltd., Suwon-si (KR)

(21) Appl. No.: 13/018,861

(22) Filed: Feb. 1, 2011

(30) Foreign Application Priority Data
Feb. 4, 2010 (KR) 10-2010-0010561

(51) Int. Cl. G06F 9/46; G06F 15/16

(52) U.S. Cl. 719/328

(57) ABSTRACT

An application executing apparatus and method to execute an application in real time in a portable terminal is provided. The application executing apparatus includes an application providing unit for transmitting execution information necessary for executing an application in real time if the application is requested from a portable terminal; and the portable terminal for executing the application in real time through the execution information, which is received from the application providing unit upon the request for the application.

### PRIORITY

This application claims priority under 35 U.S.C. §119(a) to a Korean Patent Application filed in the Korean Intellectual Property Office on Feb. 4, 2010 and assigned Serial No. 10-2010-0010561, the entire contents of which is incorporated herein by reference.

### BACKGROUND OF THE INVENTION

1. Field of the Invention The present invention relates generally to an application executing apparatus and method, and more particularly, to an apparatus and method for executing an application on a real time basis in a portable terminal.

2. Description of the Related Art Portable terminals generally download and install application execution files and related data files in order to use an application, which is received by the portable terminal from a providing unit.

Alternatively, a portable terminal may access the providing unit, which provides an application and a function corresponding to the application, in order to execute the application or provide a remote-controlled service in an operating system environment of the providing unit.

However, when the size of data for executing the application is large, it takes a long time for the portable terminal to download the application execution file and the related data file.

Moreover, although the performance of portable terminals has improved through increasingly fast hardware system resources, in order to use an application provided by the providing unit, the portable terminal must use the application in the operating system provided by the providing unit through remote access to the providing unit (i.e., the mobile terminal remotely controls an application running in the providing unit). However, in such a scheme, the application is not actually executed in the portable terminal, requiring implementation of a separate technique to use a function of the portable terminal.

Furthermore, there is a technical limitation in that the portable terminal must exchange system maintenance information with the providing unit, in addition to executing the application while a connection between the portable terminal and the providing unit is continuously maintained.

### SUMMARY OF THE INVENTION

Accordingly, an aspect of the present invention provides an application executing apparatus and method for executing an application on a real time basis in a portable terminal.

Another aspect of the present invention provides an application executing apparatus and method, which does not download the entire application, thus removing storage space constraints.

Another aspect of the present invention provides an application executing apparatus and method that executes each application in an operating system environment of the portable terminal without implementing a separate function in the portable terminal.

According to an aspect of the present invention, an application executing apparatus is provided. The application executing apparatus includes an application providing unit for transmitting execution information necessary for executing an application in real time if the application is requested from a portable terminal; and the portable terminal for executing the application in real time through the execution information received from the application providing unit.

According to another aspect of the present invention, an application executing method is provided. The application executing method includes, if an application is requested from a portable terminal, transmitting, by an application providing unit, initial execution information for executing the application; starting, by the portable terminal, execution of the application through the initial execution information upon receiving the initial execution information from the application providing unit; requesting and receiving in real time, by the portable terminal, execution information necessary for executing the application during execution of the application from the application providing unit, and executing the application in real time through the received necessary execution information.

### BRIEF DESCRIPTION OF THE DRAWINGS

The above and other features and advantages of an exemplary embodiment of the present invention will be more apparent from the following detailed description taken in conjunction with the accompanying drawings, in which:

FIG. 1 is a block diagram of an application executing apparatus according to an embodiment of the present invention; and

FIG. 2 is a flowchart illustrating an application executing method according to an embodiment f the present invention.

### DETAILED DESCRIPTION OF EMBODIMENTS OF THE PRESENT INVENTION

Hereinafter, embodiments of the present invention will be described in detail with reference to the accompanying drawings. In the accompanying drawings, like reference numerals will refer to like components throughout the drawings. In the following description, well-known functions or constructions are omitted for clarity and conciseness.

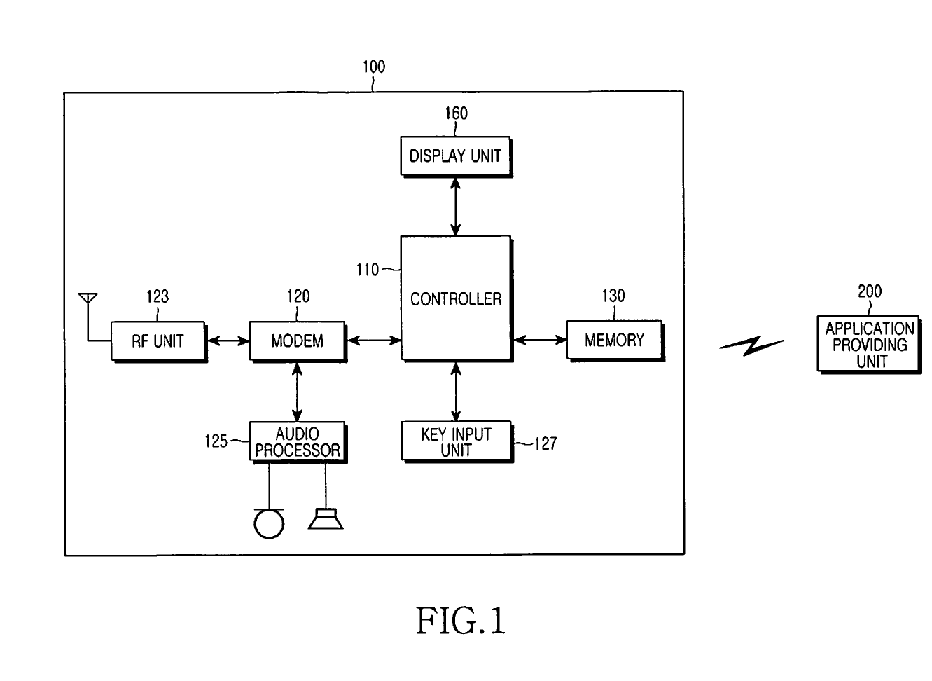

FIG. 1 is a block diagram of an application executing apparatus according to an embodiment of the present invention.

Referring to FIG. 1, the application executing apparatus includes a portable terminal 100 and an application providing unit 200.

The portable terminal 100 is connected with the application providing unit 200 to receive, from the application providing unit 200, execution information used for executing an application in real time. Then, the portable terminal 100 executes the application according to the received execution information.

The execution information includes an execution code for executing the application and execution data, which is additional data necessary for executing the application. The term “execution data” refers to an image file necessary for executing the application.

The portable terminal 100 includes a Radio Frequency (RF) unit 123, a modem 120, an audio processor 125, a memory 130, a display unit 160, a key input unit 127, and a controller 110.

The RF unit 123 performs a radio communication function of the portable terminal 100. The RF unit 123 includes an RF transmitter for up-converting a frequency of a transmission signal and amplifying the transmitted signal and an RF receiver for low-noise amplifying a received signal and down-converting the frequency of the received signal. The modem 120 includes a transmitter for encoding and modulating the transmission signal and a receiver for demodulating and decoding the received signal. The audio processor 125 may include a codec, which includes a data codec for processing packet data and an audio codec for processing an audio signal such as voice. The audio processor 125 converts a digital audio signal received from the modem 120 into an analog signal through the audio codec and reproduces the analog signal. The audio processor 125 may also convert an analog audio signal generated and transmitted from a microphone into a digital audio signal and transmits the converted digital audio signal to the modem 120. The codec may be separately provided or may be included in the controller 110.

The memory 130 includes program memory and data memory. The program memory stores programs for controlling a general operation of the portable terminal and a program capable of controlling execution of an application in the portable terminal through execution information provided, in real time, from the application providing unit 200, according to an embodiment of the present invention. The memory 130 temporarily stores data generated during execution of the programs.

The memory 130 further includes a volatile memory, which loads therein execution information received, in real time, from the application providing unit 200 during execution of the application in the portable terminal 100.

The memory 130 may store arbitrary execution information capable of maintaining the application in the portable terminal 100 if the portable terminal 100 is not connected with the application providing unit 200 or if the connection is released during reception of the execution information for executing the application from the application providing unit 200.

The memory 130 may store personal data information acquired during execution of the application, for example, game scores acquired during execution of a game application. The memory 130 may store use information such as a date when the application is executed and use hours of the application.

The display unit 160 displays user data output from the controller 110. The display unit 160 may be implemented as a touch screen that also operates as an input unit of the portable terminal 100.

The display unit 160 displays an application executed by an execution code received in real time from the application providing unit 200.

If the portable terminal 100 is not connected with the application providing unit 200 or if the connection is released during reception of the execution information for executing the application from the application providing unit 200, the display unit 160 may display a message indicating that the portable terminal 100 is not connected.

The key input unit 127 includes functional keys for setting various functions.

The controller 110 controls the overall operation of the portable terminal 100. The controller 110 may also include the modem 120 and the codec.

The controller 110, when connected with the application providing unit 200, requests the application providing unit 200 to provide an application selected from an application list received from the application providing unit 200.

Upon receiving initial execution information from the application providing unit 200, the controller 110 loads the initial execution information into the volatile memory, releases the connection with the application providing unit 200, and controls execution of the application to start through the initial execution information.

If execution information necessary for the application during execution of the application does not exist in the volatile memory, the controller 110 resumes the connection with the application providing unit 200. Upon resuming the connection, the controller 110 requests the execution information from the application providing unit 200. Upon receiving the requested execution information, the controller 100 loads the execution information into the volatile memory, releases the connection with the application providing unit 200, and controls the application to be executed through the loaded execution information.

If the connection is released during reception of the execution information from the application providing unit 200, the controller 110 maintains the application through arbitrary execution information stored in the memory 130 and displays a current state (e.g., a current connection state) on the display unit 160.

The application providing unit 200 is connected with the portable terminal 100, and if an application is requested from the portable terminal 100, the application providing unit 200 transmits execution information for executing the application to the portable terminal 100 on a real time basis.

The application providing unit 200, once connected with the portable terminal 100, verifies whether the portable terminal 100 has a use environment where an application provided by the application providing unit 200 can be executed.

If it is verified that the portable terminal 100 has a use environment where an application provided by the application providing unit 200 can be executed, the application providing unit 200 configures an application list and transmits the application list to the portable terminal 100.

If an application selected by a user from the application list is requested from the portable terminal 100, the application providing unit 200 transmits initial execution information for executing the application to the portable terminal 100.

Thereafter, when the portable terminal 100 resumes the connection with the application providing unit 200 and requests the application providing unit 200 to provide execution information necessary for executing the application, the application providing unit 200 transmits the requested execution information to the portable terminal 100, on a real time basis.

The application providing unit 200 may also store personal data information acquired during execution of the application in the portable terminal 100. For example, the personal data may include game scores acquired during execution of a game application. The application providing unit 200 may also store use information, such as a date when the application is executed in the portable terminal 100 and time information indicating use hours of the application.

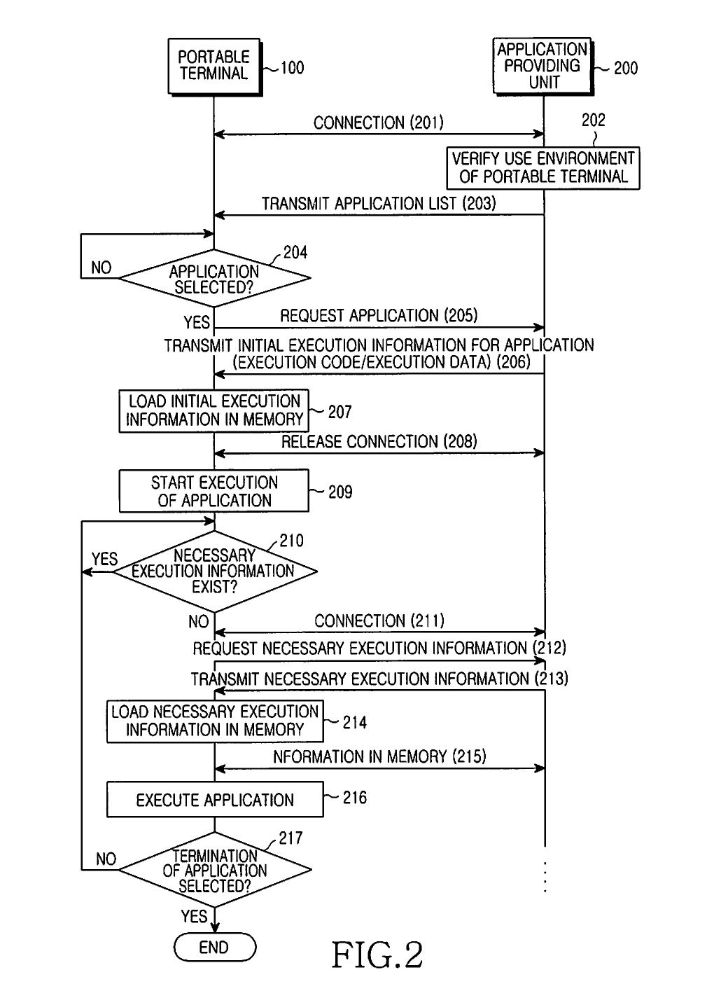

An application execution method performed in the application executing apparatus described with reference to FIG. 1 according to an embodiment of the present invention is described as follows with reference to FIG. 2.

FIG. 2 is a flowchart illustrating an application executing method performed by the application executing apparatus according to an embodiment of the present invention.

Referring to FIGS. 1 and 2, upon receiving a connection request from the portable terminal 100 in step 201, the application providing unit 200 is connected with the portable terminal 100.

Once the portable terminal 100 and the application providing unit 200 are connected with each other in step 201, the application providing unit 200 verifies whether the portable terminal 100 has a use environment where an application provided by the application providing unit 200 can be executed, in step 202.

In step 202, the application providing unit 200 verifies the use environment of the portable terminal 100, such as the size of the display unit 160 of the portable terminal 100, an available memory, controller information (e.g., Central Processing Unit (CPU) information), and access authority of a user of the portable terminal 100.

Upon verification that the portable terminal 100 has a use environment where an application provided by the application providing unit 200 can be executed, the application providing unit 200 configures an application list and transmits the configured application list to the portable terminal 100 in step 203.

Upon determining that the application list has been received from the application providing unit 200, the controller 110 of the portable terminal 100 displays the application list on the display unit 160. If the controller 100 receives input of a user selection of an application from the application list in step 204, the controller 110 senses the selection and requests the selected application from the application providing unit 200, in step 205.

At the request of the portable terminal 100 for the application, the application providing unit 200 transmits initial execution information for starting execution of the application to the portable terminal 100, in step 206. The execution information includes an execution code for executing the application and execution data, which is additional data necessary for execution of the application.

Upon determining that the initial execution code has been received from the application providing unit 200, the controller 110 of the portable terminal 100 loads the initial execution information in the volatile memory, in step 207, and releases the connection with the application providing unit 200, in step 208.

The controller 110 of the portable terminal 100 executes the application by using the initial execution information loaded in the volatile memory, in step 209.

When the application is executed in step 209, the controller 110 determines whether necessary execution information exists in the volatile memory, in step 210.

Upon determining that the execution information necessary for execution of the application exists in the volatile memory, the controller 110 continues the execution of the application. However, if it is determined that the necessary execution information does not exist in the volatile memory, the controller 110 resumes the connection with the application providing unit 220, in step 211, and requests the necessary execution information from the application providing unit 200, in step 212.

Upon determining that the requested necessary execution information has been received from the application providing unit 200, the controller 110 of the portable terminal 100 senses the reception and loads the execution information in the volatile memory, in step 214.

If the execution information requested from the portable terminal 100 is corresponding execution data, the application providing unit 200 provides only the execution data of a file including the execution data, instead of providing the entire file.

The controller 110, after loading the execution information in the volatile memory, releases the connection with the application providing unit 200, in step 215, and executes the application through the execution information loaded in the volatile memory, in step 216.

If an attempted connection with the application providing unit 200 fails in step 211, or if the connection is released before completion of the reception of the execution information from the application providing unit 200 in step 213, the controller 110 controls the application to be maintained through arbitrary execution information stored in the memory 130. The controller 110 also displays a message indicating a current state on the display unit 160 while maintaining the application through the arbitrary execution information.

The arbitrary execution information is intended to temporarily display contents other than user requested contents during execution of the application, and thus the user can recognize the current state through the message displayed on the display unit 160 and use the displayed contents until the user requested contents are executed.

Once the connection with the application providing unit 200 is resumed, the controller 110 indicates the resumption of the connection on the display unit 160 and executes the application while displaying the user requested contents.

By repeating steps 210 through 216, the portable terminal 100 repeatedly connects and disconnects with the application providing unit 200, while executing the application through execution information received in real time from the application providing unit 200.

If termination of the application is selected by the user, during execution of the application in step 217, the controller 110 senses the selection and terminates execution of the application.

The personal data information acquired during execution of the application (e.g., game scores acquired during execution of a game application, or use information such as a date when the application is executed and use hours of the application) may be stored in the portable terminal 100 or the application providing unit 200 according to a user's selection.

With the application executing apparatus and method according to the present invention, various kinds of applications can be executed in a portable terminal having a relatively small space, regardless of the size of a storage device. Moreover, a feature of executing an application in the portable terminal removes restrictions in using resources of the portable terminal. Furthermore, the application can be executed even in a situation where connection between the portable terminal and the application providing unit may not be maintained for a long time.

While the present invention has been shown and described with reference to an embodiment thereof, it will be understood by those skilled in the art that various changes in form and details may be made therein without departing from the spirit and scope of the invention as defined by the appended claims and equivalents thereof.

What is claimed is:

1. An application executing apparatus comprising:
an application providing unit for, if an application is requested from a portable terminal, transmitting execution information necessary for executing the application in real time; and
the portable terminal for receiving the transmitted execution information, and executing the application in real time through the received execution information.

2. The application executing apparatus of claim 1, wherein the execution information includes an execution code for executing the application and execution data, and
wherein the execution data is additional data necessary for executing the application.

3. The application executing apparatus of claim 1, wherein when the application providing unit is connected with the portable terminal, the application providing unit transmits an application list to the portable terminal,
when a request for an application selected from the application list is received from the portable terminal, the application providing unit transmits initial execution information for executing the selected application, and
when execution information necessary for executing the selected application is received from the portable terminal, the application providing unit transmits the requested execution information to the portable terminal, in real time.

4. The application executing apparatus of claim 3, wherein when the application providing unit is connected to the portable terminal, the application providing unit verifies whether the portable terminal has a use environment in which an application provided by the application providing unit can be executed, and then transmits the application list to the portable terminal.

5. The application executing apparatus of claim 1, wherein when the portable terminal is connected to the application providing unit, the portable terminal transmits, to the application providing unit, a request for the application providing unit to provide an application selected from an application list received from the application providing unit, and
wherein the portable terminal starts executing the application through initial execution information received from the application providing unit in response to the request for the selected application.

6. The application executing apparatus of claim 5, wherein upon receiving the initial execution information from the application providing unit, the portable information stores the initial execution information in a volatile memory and then releases a connection with the application providing unit.

7. The application executing apparatus of claim 5, wherein if execution information necessary for executing the application does not exist in the portable terminal, the portable terminal connects with the application providing unit and requests the necessary execution information from the application providing unit.

8. The application executing apparatus of claim 7, wherein upon receiving the necessary execution information from the application providing unit, the portable terminal stores the necessary execution information in the volatile memory and releases a connection with the application providing unit.

9. The application executing apparatus of claim 7, wherein if a connection with the application providing unit is released during reception of the necessary execution information from the application providing unit, the portable terminal maintains execution of the application by using arbitrary execution information stored in the portable terminal and displays a message indicating the release of the connection with the application providing unit.

10. An application executing method comprising:
if an application is requested from a portable terminal, transmitting, by an application providing unit, initial execution information for executing the application;
upon receiving the initial execution information from the application providing unit, starting, by the portable terminal, execution of the application through the initial execution information;
requesting, and receiving in real time, by the portable terminal, from the application providing unit, execution information necessary for executing the application during execution of the application; and
executing the application in real time through the received necessary execution information.

11. The application executing method of claim 10, wherein the execution information includes an execution code for executing the application and execution data,
wherein the execution data is additional data necessary for executing the application.

12. The application executing method of claim 10, wherein transmitting the initial execution information comprises:
when the application is requested from the portable terminal, verifying, by the application providing unit, whether the portable terminal has a use environment in which an application provided by the application providing unit can be executed;
if the portable terminal has the use environment in which the application can be executed, providing, by the application providing unit, an application list to the portable terminal; and
if an application selected from the application list is requested from the portable terminal, transmitting, by the application providing unit, initial execution information for the application.

13. The application executing method of claim 10, further comprising, upon receiving the initial execution information from the application providing unit, loading, by the portable terminal, the initial execution information into a volatile memory and releasing a connection with the application providing unit.

14. The application executing method of claim 10, wherein executing the application through the necessary execution information comprises:
determining, by the portable terminal during execution of the application, whether the necessary execution information exists in the portable terminal;
if the necessary execution information does not exist in the portable terminal, requesting the necessary execution information from the application providing unit; and
upon receiving the necessary execution information in real time from the application providing unit, executing the application in real time through the necessary execution information.

15. The application executing method of claim 14, further comprising, if the necessary execution information does not exist in the portable terminal, resuming, by the portable terminal, a connection with the application providing unit and requesting the necessary execution information from the application providing unit.

16. The application executing method of claim 14, further comprising, upon receiving the necessary execution information in real time from the application providing unit, loading, by the portable terminal, the necessary execution information into a volatile memory and releasing a connection with the application providing unit.

17. The application executing method of claim 14, further comprising, if a connection is released during reception of the necessary execution information from the application providing unit, maintaining, by the portable terminal, the application through arbitrary execution information and displaying a message indicating a release of the connection with the application providing unit.
